(19) United States
(12) Patent Application Publication
(10) Pub. No.: US 2004/0239183 A1
(43) Pub. Date: Dec. 2, 2004

(54) Child safety system for motor vehicles

(76) Inventors: Alejandro Delgado, Miami, FL (US); Guilermo Leon Londono, Miami, FL (US)

Correspondence Address: MARVIN A. NAIGUR, 254 SW 180TH AV., PEMBROKE PINES, FL, 33029, US

(21) Appl. No.: 10/452,862

(22) Filed: Jun. 2, 2003

(51) Int. Cl. B60L 3/00

(52) U.S. Cl. 307/10.1

(57) ABSTRACT

A child safety system is provided for motor vehicles in which the driver side door switch is electrically connected to the vehicle battery to activate the vehicle interior lighting system when the door is opened. In accordance with the present invention, a child safety seat is provided with an electrical circuit including a pressure sensitive switch with an alarm and a circuit with a connector for connection to the door switch circuit. The electrical circuit of the child safety seat is activated by the weight of a child on the pressure sensitive switch when the child is placed in the child safety seat. When the child safety seat is plugged into the vehicle driver side door circuit the alarm will be activated when the driver side door is opened with a child present in the safety seat. In this manner, when a child is not strapped into the seat, the child safety seat can either remain unplugged on the rear seat of the vehicle or plugged into the door circuit, and the electrical circuit and alarm will be disconnected form the door circuit.

### BACKGROUND FOR THE INVENTION

The present invention relates to a child safety system for preventing catastrophic injury, which can even result in death, to young children inadvertently left unattended in a motor vehicle. There have been numerous situations where the operator of a motor vehicle, having parked the vehicle during harsh climate conditions, leaves the vehicle forgetting that an infant or small child has been left in the rear seat of the vehicle strapped into a child safety seat. This type of problem is exacerbated in very hot or very cold climate conditions, in which the parked vehicle can quickly become a death trap for young children who are unable to leave the vehicle of their own accord due to being strapped in the child safety seat. In many instances, the parent will inadvertently loose sight of the amount of time that a child has spent in the rear of the vehicle. In accordance with the present invention the conventional child safety seat is provided with a safety system that can easily be connected to the door electrical circuitry of a motor vehicle. Also, a weight sensitive switch on the safety seat, completes the electrical circuit essentially comprised of an alarm system, the vehicle driver side door switch and car battery, such that the alarm will sound any time the driver side door is opened, when a child is strapped into the safety seat. Furthermore, since the child safety system of the present invention is connected directly to the vehicle battery through the driver side door switch, the alarm system can operate independent of the vehicle ignition system, thereby eliminating the necessity of the ignition key being turned in either the on position or off position in order for the child safety system of the present invention to be operational. Thus, in accordance with the present invention, a simple yet extremely effective child safety system has been provided to prevent inadvertently allowing small children to be left unattended in the rear of the motor vehicles, particularly during very hot or cold climatic conditions.

### SUMMARY OF THE INVENTION

In accordance with illustrative embodiments demonstrating features and advantages of the present invention, there is provided a child safety system for a motor vehicle. The vehicle for accommodating the child safety system of the present invention requires the conventional driver side door switch to be electrically connected to the car battery for activating the vehicle interior lighting system when the door is opened. Accordingly, the present invention takes advantage of this conventional door system by providing a child car seat that can easily be plugged into a connector that has been developed for incorporation into the vehicle door electrical circuit. A pressure sensitive electric switch is mounted on the child seat and an alarm is electrically connected thereto. An electrical connector is connected to the pressure sensitive switch and alarm system for easy connection to the electrical connector provided for the car door electrical circuit.

### BRIEF DESCRIPTION OF THE DRAWINGS

The above brief description, as well as further objects, features and advantages of the present invention, will be more fully appreciated by references to the following detailed description of presently preferred but nonetheless illustrative embodiments in accordance with the present invention, when taken in connection with the accompanying drawings within:

FIG. 1 is a perspective view of the child safety seat of the present inventions with the seat cushion removed to show the transparent mounting plate and pressure sensitive switch;

FIG. 2 is a schematic diagram showing the electrical circuit and components of the present invention connected to the door switch and electrical system of a motor vehicle;

FIG. 3 is an enlarged view of the door switch shown in FIG. 2, with the door switch in an open position when the drivers side door in a closed position;

FIG. 4 is an enlarged view of the door switch shown in FIG. 2, with the door switch in a closed position when the drivers side door is in an open position.

FIG. 5 is a front view of the car seat switch shown in FIG. 2, with the front of the housing removed to better show the pressure sensitive switch; and

FIG. 6 is a schematic circuit diagram of the child safety system of the present invention integrated with the electrical system of a conventional motor vehicle.

### DESCRIPTION OF THE PREFFERED EMBODIMENT

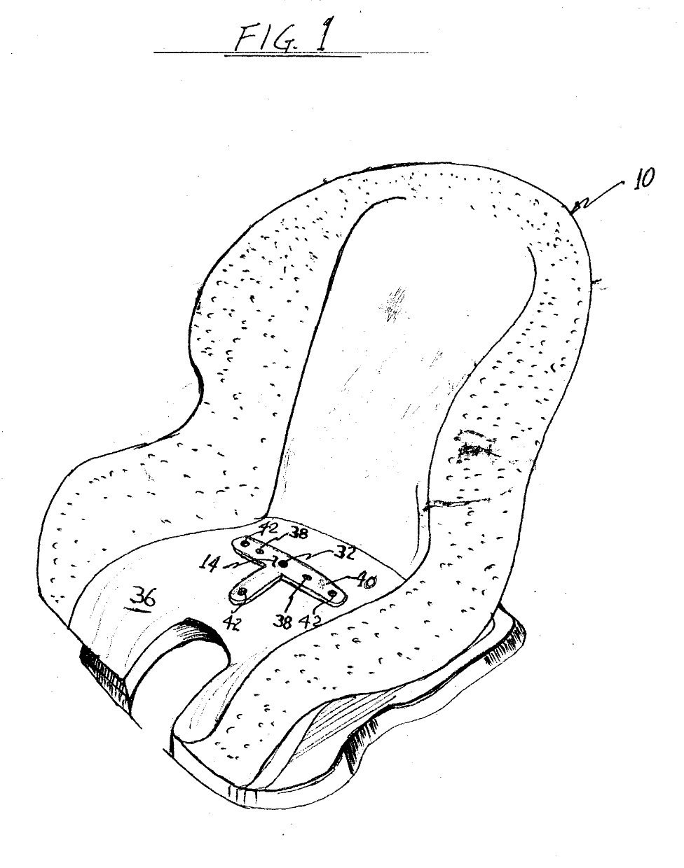

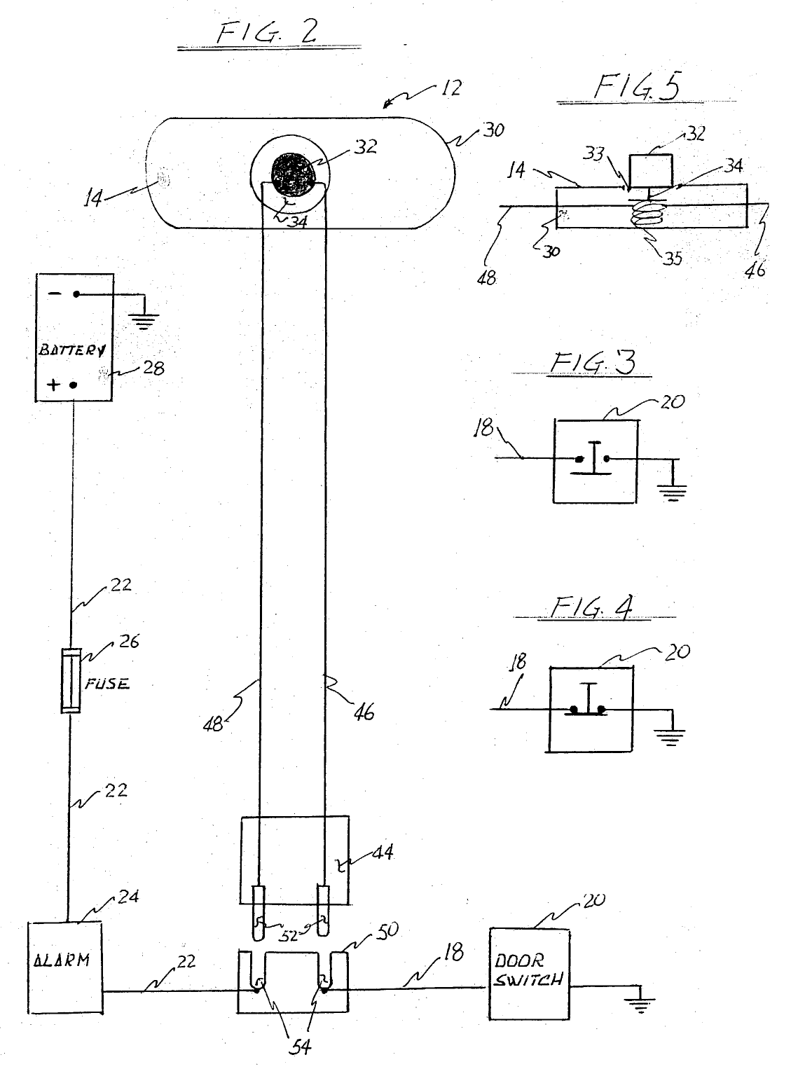

With reference to FIG. 1, a child safety seat is generally referred to by the reference numeral 10, and as shown in FIG. 2 a child safety system generally referred to by the reference numeral 12 is integrated into the child safety seat 10. The child safety system 12 includes a car seat switch 14 that is mounted on the child safety seat 10 and connected to the vehicle by means of an electric circuit 16.

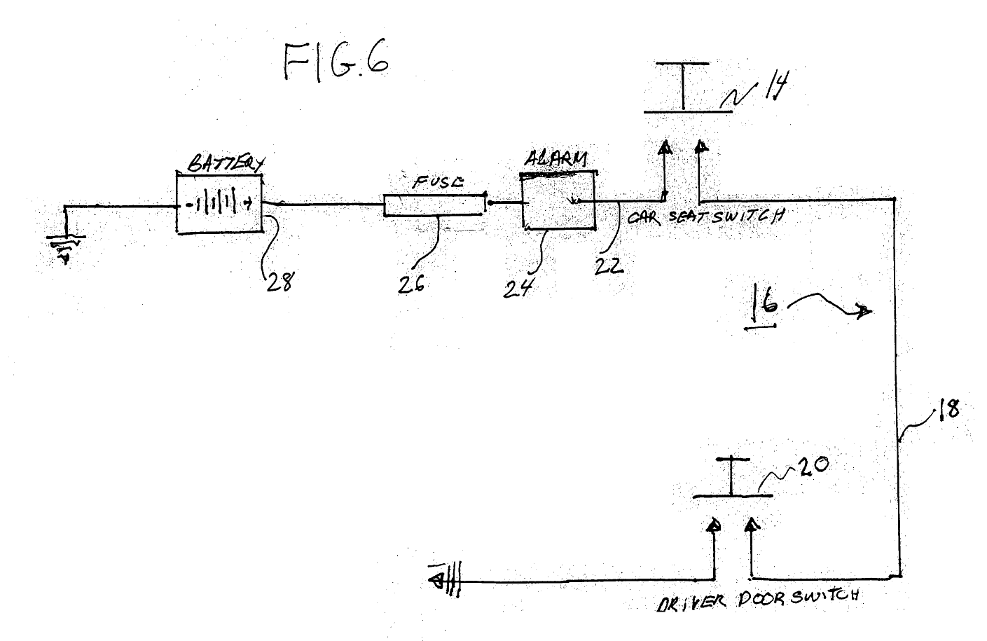

As best shown in FIG. 6 the electric circuit 16 includes a first electrical connection 18 from the car seat switch 14 to the driver door switch 20 that is conventionally provided in motor vehicles. The electric circuit 16 is completed by providing a second electrical connection 22 extending from the car seat switch 14 to an alarm 24, fuse 26 and a car battery 28, thereby completing the circuit.

The car seat switch 14 as shown in FIG. 5 includes a base housing 30 for accommodating an activation button 32 through an opening 33 formed on the top of base housing 30. The car seat switch 14 has been developed through modifying a conventional doorbell switch by forming the activation button 32 from a pliable and compressible material such as rubber or plastic. As shown in FIG. 5, an activation switch 34 is mounted on the bottom of activation button 32, with a spring 35 mounted between the bottom of housing 30 and activation button 32. Accordingly, the resiliency and compressibility of the material of activation button 32, as well as the positioning of the car seat switch 14, will afford completion of the electric circuit 16 by the pressure on activation button 32 created by the weight of a child placed in the safety seat 10. Moreover, when there is not any child present in the safety seat 12, thereby removing the pressure from the activation button 32, the electric circuit 16 will remain open and inactive, to allow the driver side-door of the vehicle to be opened without setting off the alarm 24.

Turning to FIG. 1, the child safety seat 10 is shown with the usual restraining straps and padding removed, such that upper seating surface 36 of the safety seat 10 is completely exposed. Since the conventional child safety seat is fabricated of rigid plastic material, it is possible to form the opening 34 in the seating surface 36 to accommodate the activation button 32. The car seat switch 14 is mounted on the opposite side of seating surface 36 by a pair of bolts 38. A t-shaped pressure plate 40 formed from transparent plastic material is mounted on the seating surface 36 by bolts 42. Accordingly, through the coextensive contact of the upper surface of actuation button 32 with the lower surface of pressure plate 40 as well as the pressure exerted by the weight of a child seated in the child safety seat 10, it is possible to maintain the car seat switch 14 in a closed position, whereby the electric circuit 16 to the alarm 24 is not activated and will only be activated when the driver side door of the vehicle is opened. Accordingly, the door switch 20 will be in the closed position as shown in FIG. 4, when the driver side door is closed while a child is placed in the safety seat 12. By providing the pressure plate 40 in combination with the compressible material of activation button 32, it is possible to place the standard quilted material of a conventional child safety seat 10 over the car safety switch without causing discomfort to the child placed on the seating surface 36, and at the same time maintain the car seat in the closed position such that the electrical circuit 16 can only be activated upon opening of the driver side door of the vehicle. The pressure plate 40, also serves as a means for distributing the pressure created by the weight of the child over a wider area of the seating surface 36 to better transfer the force to the activation button 32 for maintaining the car switch 14 in a closed position and the electric circuit 16 in an open condition.

In order to facilitate connecting the safety seat 10 to the motor vehicle, a detachable connector plug 44 is connected to the car seat switch 14 by means of connecting lines 46 and 48, and a receptacle plug 50 is connected to the door switch 20 by the line 18. The plugs 46 and 50 are respectively formed with connectors 52 and 54 for easily connecting and disconnecting the car seat 10 to the motor vehicle. While the connector plug 44 is shown with male connectors 52 and the receptacle plug 50 is shown with female connectors 54, it can be appreciated that the male and female connectors could easily be reversed for the connector plug 44 and receptacle plug 50, respectively. Thus, in accordance with the child safety system 12 of the present invention, the conventional door switch electric circuit of a motor vehicle has been modified, by integrating the receptacle plug 50 with electric connection 18 into such electric circuit. In this manner it is possible to utilize much of the existing door switch interior lighting system of a motor vehicle in accordance with the present invention.

Turning to FIGS. 1 and 2, the operation of the child safety system 12 can be more readily appreciated by considering the placement of a child in a child safety seat 10 in a motor vehicle. Accordingly, the child safety seat 10 is secured to the rear seat of the motor vehicle, and the connector plug 44 from the safety seat 10 is then inserted into the receptacle plug 50 from the car door switch 20 that is preferably located in the rear seating area of the vehicle for easy access. Prior to placing the child in the safety seat 10, the car seat switch 14 remains in an open position, and the weight of the child causes the activation switch 34 to remain closed such that the car seat switch 14 is in an activated position. Thus, when the driver side door is opened with the child in the safety seat 10, the door switch 20 will move into closed position of FIG. 4 and activate alarm 24. When the child safety seat 10 is not in use it can either be left fully operational in the motor vehicle or easily be removed by detaching plugs 44 and 50.

Additional modifications, changes and substitution are intended in the foregoing disclosure, and, in some instances, some features of the invention will be employed without corresponding use of other features. Accordingly, it is appropriate that the appended claims be construed broadly and in a manner consistent with the spirit and scope of the invention herein.

What is claimed is:

1) A child safety system for a motor vehicle, including a door, a battery providing a source of electricity, and a door switch in an electrical circuit connected to said battery, such that said electrical circuit is in an open and inactivated condition when said door is in a closed position and a closed and activated condition when said door is in an open position, the child safety system comprising control means electrically connected to said door switch for generating an alarm signal upon detecting the weight of an occupant contacting said control means when said door is in the open position.

2) A child safety system according to claim 1, in which said control means includes a pressure sensitive switch on the vehicle seat for activation by the weight of a vehicle occupant and an alarm electrically connected to the said pressure sensitive switch and said door switch, whereby an audible alarm signal is generated when said pressure sensitive switch is activated by the weight of the vehicle occupant contacting said pressure sensitive switch and said door is also in the open position.

3) A child safety system according to claim 2 in which a child seat is capable of being located on the seat of the vehicle, and said switching means comprises an electrical switch and an audible alarm mounted on said child seat, and a second electrical connection means connected to said switching means whereby said first electrical connection means is capable of being joined to said second electrical connection means to complete said electrical circuit with said door switch and said alarm.

4) A child safety system according to claim 3 in which said first electrical connector consists of a male connector and said second electrical connector consists of a female electrical connector for receiving said male connector whereby said child seat is capable of being detachably connected to said electrical circuit including said door switch means and said vehicle battery.

5) A child safety system according to claim 4, in which the seating surface of said child safety seat is formed with a seat opening for receiving and mounting said pressure sensitive switch in a position whereby the weight of the occupant of said child safety seat will cause said pressure sensitive switch to complete the electrical circuit to said alarm.

6) A child safety system according to claim 5 in which activation means is provided on said pressure sensitive switch and mounted beneath said seating surface to extend upward through said seat opening beyond the horizontal plane of said seating surface, such that the weight of the child occupant provides sufficient pressure to place said pressure sensitive switch in a closed position whereby the electrical circuit to said alarm is not activated and is activated when said door is in an open position.

7) A child safety system according to claim 6, in which said pressure sensitive switch includes an activation button extending through seat said opening, and a plate mounted on the outer surface of said seat and having an opening coextensive with said seat opening such that said activation button does not extensively protrude beyond said seating surface to cause discomfort to the occupant of the child seat.
